(19) United States
(12) Patent Application Publication
(10) Pub. No.: US 2013/0082090 A1
(43) Pub. Date: Apr. 4, 2013

(54) METHODS OF FORMING CONNECTION BUMP OF SEMICONDUCTOR DEVICE

(71) Applicants: Moon-gi CHO, Suwon-si (KR); Hwan-sik LIM, Gunpo-si (KR); Sun-hee PARK, Seoul (KR)

(72) Inventors: Moon-gi CHO, Suwon-si (KR); Hwan-sik LIM, Gunpo-si (KR); Sun-hee PARK, Seoul (KR)

(73) Assignee: SAMSUNG ELECTRONICS CO., LTD., Suwon-si (KR)

(21) Appl. No.: 13/614,608

(22) Filed: Sep. 13, 2012

(30) Foreign Application Priority Data
Sep. 30, 2011 (KR) 10-2011-0100032

(51) Int. Cl. B23K 31/02; B23K 1/20

(52) U.S. Cl. 228/176; 228/203

(57) ABSTRACT

Methods of forming connection bumps for semiconductor devices in which rewiring patterns are formed. The method includes preparing a semiconductor substrate on which a pad is partially exposed through a passivation film, forming a seed layer on the pad and passivation film, forming a photoresist pattern including an opening pattern comprising a first opening that exposes a portion of the seed layer on the pad and a second opening that exposes a portion of the seed layer on the passivation film and is separated from the first opening, performing a first electroplating to form filler layers in the opening patterns, performing a second electroplating to form a solder layer on the filler layers, removing the photoresist pattern and performing a reflow process to form a collapsed solder layer that electrically connects the filler layers to each other and a solder bump on the filler layer formed in the second opening.

### CROSS-REFERENCE TO RELATED APPLICATIONS

This application claims the benefit of Korean Patent Application No. 10-2011-0100032, filed on Sep. 30, 2011, in the Korean Intellectual Property Office, the disclosure of which is incorporated herein in its entirety by reference.

### BACKGROUND

Example embodiments of inventive concepts relate to methods of forming connection bumps on semiconductor devices, for example, to methods of forming connection bumps on semiconductor devices that have rewiring patterns.

Semiconductor chips that have semiconductor devices extend their internal circuit functions to external electronic apparatuses through pads. Up to now, pads of semiconductor chips are connected to external printed circuit boards (PCB) mainly through bonding wires. However, as semiconductor devices are miniaturized, as the processing speed is gradually increased, and as the numbers of input/output signals in the semiconductor chips is increased, a method of directly connecting the connection bumps formed on the pads of a semiconductor chip to a PCB is increasingly more difficult. In the connection to the PCB through connection bumps, increased reliability and reduced process time/cost are desired.

### SUMMARY

Example embodiments of inventive concepts provide methods of forming connection bumps of semiconductor devices formed with rewiring patterns.

According to example embodiments of inventive concepts, there is provided a method of forming a connection bump of a semiconductor device, the method comprising: preparing a semiconductor substrate on which a pad is partially exposed through a passivation film; forming a seed layer on the pad and the passivation film; forming a photoresist pattern on the pad and a second opening, the photoresist pattern including an opening pattern that includes a first opening that exposes a portion of the seed layer on the passivation film and is separated from the first opening; performing a first electroplating to form filler layers in the opening patterns; performing a second electroplating to form a solder layer on the filler layers; removing the photoresist pattern; and performing a reflow process to form a collapsed solder layer that electrically connects the filler layers to each other and to a solder bump on the filler layer formed in the second opening.

In example embodiments, the performing of the reflow process may include forming the collapsed solder layer by dissolving a portion of the solder layer that is formed on the filler layer formed in the first opening.

In example embodiments, the method may further include removing the portion of the seed layer exposed by the filler layers and the collapsed solder layer after performing the reflow process.

In example embodiments, the narrowest width of the first opening may be smaller than the narrowest width of the second opening so that the collapsed solder layer is formed by dissolving a portion of the solder layer that is formed on the filler layer formed in the first opening, and the solder bump is formed by the solder layer that is formed on the filler layer formed in the second opening.

In example embodiments, the opening patterns may further include at least one middle opening that is between the first opening and the second opening and the middle opening is separated from the first opening and the second opening, respectively.

In example embodiments, the first opening and the at least one middle opening may have cross sections of the same shape, and the first opening and the at least one middle opening may be repeatedly disposed in a direction towards the second opening.

In example embodiments, the performing of the reflow process may include forming the collapsed solder layer by dissolving a portion of the solder layer formed on the filler layer that is formed in the first opening and the middle opening.

In example embodiments, the performing of the reflow process may include forming the collapsed solder layer by dissolving a portion of the solder layer that is formed on the filler layer formed in the first opening and the middle opening so that the collapsed solder layer contacts the filler layer formed in the second opening.

In example embodiments, the he forming of the photoresist pattern may further include forming the photoresist pattern that corresponds to a dummy opening that is separated from the opening pattern and exposes a portion of the seed layer on the passivation film, the performing of the first electroplating may include forming a dummy filler layer in the dummy opening, and the forming of the second electroplating may include forming the dummy solder layer on the dummy filler layer.

In example embodiments, the performing of the reflow process may include forming the dummy solder bump on the dummy filler layer.

In example embodiments, the performing of the reflow process may include forming the uppermost surfaces of the solder bump and the dummy solder bump on the semiconductor substrate at the same level.

In example embodiments, the performing of the reflow process may include forming the uppermost surface of the collapsed solder layer at a lower level than the uppermost surface of the solder bump on the semiconductor substrate.

In example embodiments, the method may further include removing the portions of the seed layer exposed by the filler layers and the collapsed solder layer so that the filler layer, the solder bump, and the collapsed solder layer, respectively, are electrically insulated from the dummy filler layer and the dummy solder bump after performing the reflow process.

According to other example embodiments of inventive concepts, there is provided a method of forming a connection bump of a semiconductor device, the method including: preparing a semiconductor substrate on which a pad is partially exposed through a passivation film; forming filler layers separated from each other, each of the filler layers including a bump filler pattern on a passivation film, a connection filler pattern on the pad to partly overlap with the pad, and at least one middle filler pattern between the bump filler pattern and the connection filler pattern; forming a solder layer on the filler layers; and forming a collapsed solder layer that electrically connects the pad to the bump filler pattern by dissolving the solder layer formed on the connection filler pattern and the middle filler pattern.

In example embodiments, the filler pattern may further include an auxiliary filler pattern that is on the passivation film and is separated respectively from the bump filler pattern, the connection filler pattern, and the middle filler pattern, the forming of the collapsed solder layer may include electrically insulating the pad from the auxiliary filler pattern.

According to yet other example embodiments of inventive concepts, there is provided a method or forming electrical connections in a semiconductor device including a first filler layer with a solder layer on the first filler layer, a second filler layer with a solder bump on the second filler layer and a pad, the pad being partly covered by the first filler layer, layer, the method comprising forming a collapsed solder layer on the semiconductor device, and electrically connecting the first filler layer, the second filler layer, the pad and the solder bump.

In example embodiments, the first filler layer may be formed to have a width smaller than a width of the second filler layer.

In example embodiments, the method may include finely controlling the direction of collapsing the solder layer.

In example embodiments, the method may include forming a dummy filler layer on the semiconductor device and forming a dummy solder bump on the dummy filler layer.

In example embodiments, the method may include forming the dummy filler layer and forming the dummy solder bump such that the dummy filler layer and the dummy solder bump are electrically insulated from the pad.

### BRIEF DESCRIPTION OF THE DRAWINGS

Example embodiments of inventive concepts will be more clearly understood from the following detailed description taken in conjunction with the accompanying drawings in which:

FIG. 1 is a plan view showing an operation of preparing a semiconductor substrate formed with a pad, according to example embodiments of inventive concepts;

FIG. 2 is a cross-sectional view showing an operation of preparing a semiconductor substrate formed with a pad, according to example embodiments of inventive concepts;

FIG. 3 is a cross-sectional view showing an operation of forming a barrier wall layer according to example embodiments of the inventive concepts;

FIG. 4 is a cross-sectional view showing an operation of forming a seed layer according to example embodiments of inventive concepts;

FIGS. 5 is a plan view showing an operation of forming a photoresist pattern, according to example embodiments of inventive concepts;

FIG. 6 is a cross-sectional view showing an operation of forming a photoresist pattern, according to example embodiments of inventive concepts;

FIG. 7 is a cross-sectional view showing an operation of forming a filler layer according to example embodiments of inventive concepts;

FIG. 8 is a cross-sectional view showing an operation of forming a solder layer according to example embodiments of inventive concepts;

FIG. 9 is a cross-sectional view showing an operation of removing the photoresist pattern according to example embodiments of inventive concepts;

FIGS. 10 and 11 are respectively, a plan view and a cross-sectional view showing an operation of performing a reflow process, according to example embodiments of inventive concepts;

FIG. 12 is a cross-sectional view showing an operation of forming connection bumps according to example embodiments of inventive concepts;

FIG. 13 is a plan view showing an example operation of forming a photoresist pattern and a collapsed solder layer, according to other example embodiments of inventive concepts;

FIG. 14 is a plan view showing example operations of forming a photoresist pattern and a collapsed solder layer, according to other example embodiments of inventive concepts; and

FIG. 15 is a flowchart illustrating a method of forming a bump according to example embodiments of inventive concepts.

### DETAILED DESCRIPTION OF EXAMPLE EMBODIMENTS

Example embodiments will now be described more fully with reference to the accompanying drawings. Example embodiments may, however, be embodied in many different forms and should not be construed as being limited to the embodiments set forth herein; rather, these embodiments are provided so that this disclosure will be thorough and complete, and will fully convey the concept of example embodiments to those of ordinary skill in the art. In the drawings, the thicknesses of layers and regions are exaggerated for clarity. Like reference numerals in the drawings denote like elements throughout, and thus their description will be omitted.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. As used herein the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms “first”, “second”, etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of example embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of example embodiments. As used herein, the singular forms “a,” “an” and “the” are intended to include the plural forms as well, unless the context clearly indicates otherwise. It will be further understood that the terms “comprises”, “comprising”, “includes” and/or “including,” if used herein, specify the presence of stated features, integers, steps, operations, elements and/or components, but do not preclude the presence or addition of one or more other features, integers, steps, operations, elements, components and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the particular shapes of regions illustrated herein but are to include deviations in shapes that result, for example, from manufacturing. For example, an implanted region illustrated as a rectangle may have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of example embodiments. It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Unless otherwise defined, all terms (including technical and scientific terms) used herein have the same meaning as commonly understood by one of ordinary skill in the art to which example embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

The attached drawings for illustrating example embodiments of inventive concepts are referred to in order to gain a sufficient understanding of inventive concepts and the merits thereof. Hereinafter, inventive concepts will be described in detail by explaining embodiments of inventive concepts with reference to the attached drawings. Like reference numerals in the drawings denote like elements.

FIGS. 1 and 2 are respectively, a plan view and a cross-sectional view showing an operation of preparing a semiconductor substrate 100 that is formed with thereon a pad 112, according to example embodiments of inventive concepts. More specifically, FIG. 2 is a cross-sectional view taken along the line II-II′ of FIG. 1.

FIGS. 1 and 2 illustrate preparation of the semiconductor substrate 100. Semiconductor substrate 100, supporting the pad 112, may extend the function of the circuit formed within the semiconductor substrate 100 externally. The semiconductor substrate 100 may be a semiconductor wafer substrate in which a plurality of semiconductor chips that are arranged in matrix form and may be separated from each other by scribe lanes.

A circuit unit that includes individual unit devices for functioning circuits of a semiconductor device may be formed in the semiconductor substrate 100 through a semiconductor manufacturing process. That is, the semiconductor substrate 100 may be formed to include transistors, resistors, capacitors, conductive wires, and insulating films disposed therebetween.

The pad 112 may be partially exposed through a passivation film 104, which is a final protective layer of the circuit unit of the semiconductor device. The pad 112 may electrically connect the semiconductor device to an external apparatus by being electrically connected to the circuit unit of the semiconductor device.

The semiconductor substrate 100 may be formed with various semiconductor devices therein, for example, memory devices, such as a DRAM or a flash memory, logic devices such as a micro controller, analog devices, digital signal processing devices, system on chip devices, or a combination of these devices.

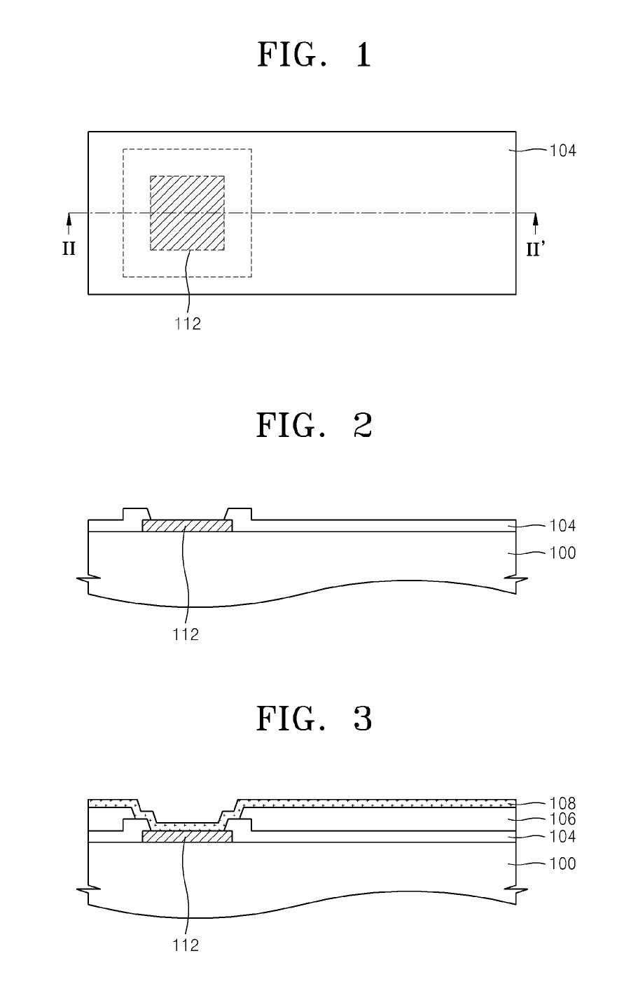

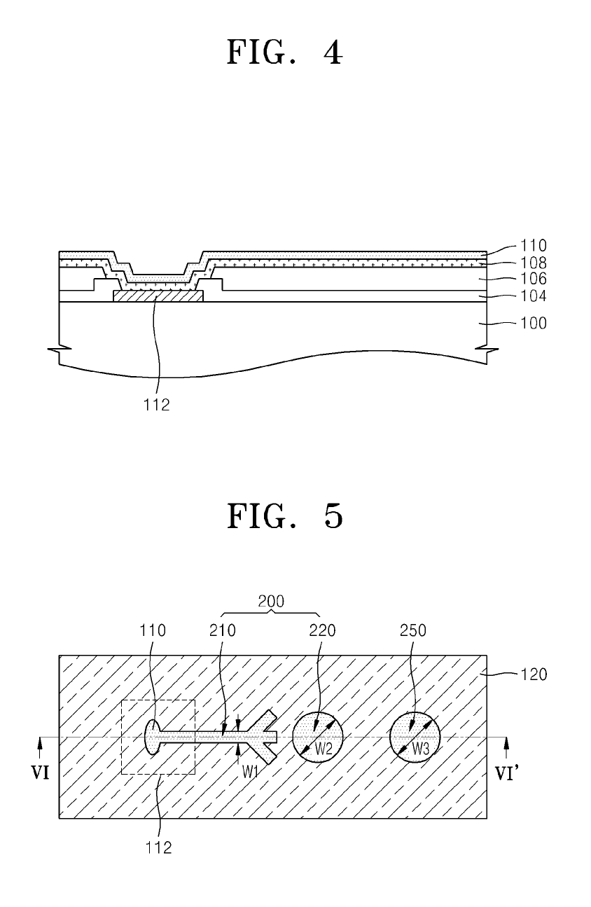

FIG. 3 is a cross-sectional view showing an operation of forming a barrier wall layer 108, according to example embodiments of inventive concepts. FIG. 3 and FIG. 4, illustrate cross-sections taken along II-II′ of FIG. 1 after performing subsequent processes, described below.

Referring to FIG. 3, the barrier wall layer 108 covering the entire surface of semiconductor substrate 100 may be formed. The barrier wall layer 108 may be formed of, for example, titanium (Ti) or titanium tungsten (TiW). The barrier wall layer 108 may be formed by a chemical vapor deposition (CVD) method or a physical vapor deposition (PVD) method, such as sputtering, to have a thickness in a range from about 500 Å to about 4,000 Å.

A buffer insulating film 106 may be formed between the barrier wall layer 108 and the passivation film 104. The buffer insulating film 106 may be formed to partially expose the pad 112 through an etching process, after depositing the buffer insulating film 106 on the entire surface of the semiconductor substrate 100 and forming a photoresist pattern (not shown). The buffer insulating film 106 may be formed of, for example, polyimide or epoxy resin.

FIG. 4 is a cross-sectional view showing an operation of forming a seed layer 110, according to example embodiments of inventive concepts.

Referring to FIG. 4, the seed layer 110 is formed on the entire surface of the semiconductor substrate 100. The seed layer 110 may be formed of, for example, a metal including Cu, Ni, Au, or other similar materials. The seed layer 110 may be formed by a CVD method or a PVD method, such as sputtering, to have a thickness in a range from about 1,000 Å to about 4,000 Å.

Forming the barrier wall layer 108 may reduce or prevent a material of the seed layer 110 from diffusing into the lower layers. The barrier wall layer 108 may function as an adhesive layer so that the seed layer 110 is attached onto the lower material layers, for example, the pad 112, the passivation film 104, or the buffer insulating film 106.

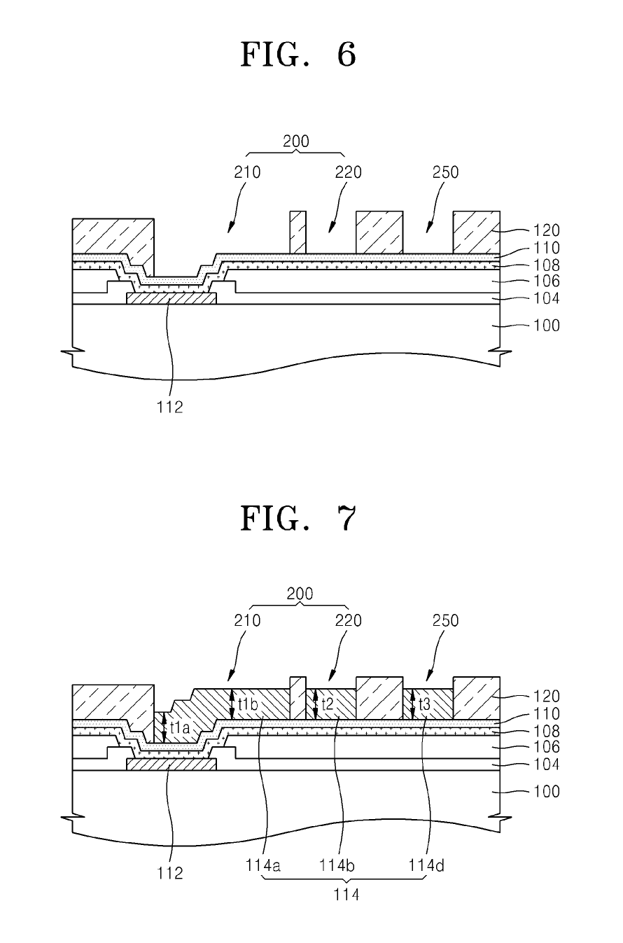

FIG. 5 is, is a plan view showing an operation of forming a photoresist pattern 120, and FIG. 6 is a cross sectional view showing an operation of forming a photoresist pattern 120, according to example embodiments of inventive concepts. For example, FIG. 6 is a cross-sectional view taken along the line VI-VI′ of FIG. 5.

Referring to FIGS. 5 and 6, the photoresist pattern 120 is formed on the seed layer 110. An opening pattern 200 that exposes a portion of the seed layer 110 may be formed in the photoresist pattern 120.

The opening pattern 200 may include a first opening 210 and a second opening 220. The first opening 210 may expose a portion of the seed layer 110 above the pad 112. The second opening 220 may expose a portion of the seed layer 110 above the passivation film 104. The first opening 210 may expose a portion of the seed layer 110 above the passivation film 104 and may expose a portion of the seed layer 110 above the pad 112. The second opening 220 may be formed to only expose a portion of the seed layer 110 above the passivation film 104 and not to expose a portion of the seed layer 110 above the pad 112.

The first opening 210 is separated and spaced apart from the second opening 220, and an end of the first opening 210 may be formed adjacent to the second opening 220. The narrowest width W1 of the first opening 210 may be formed to be shorter than the narrowest width W2 of the second opening 220. All widths of the first opening 210 may be formed shorter than the narrowest width W2 of the second opening 220. That is, the first opening 210 may be formed as a linear opening having a width shorter than the narrowest width W2 of the second opening 220 or the first opening may be formed as a combination of linear openings.

The second opening 220 may have any geometric shape such as a circle, a rectangle or any other polygon; all of such openings are referred to herein as “polygonally shaped”. The second opening 220 may have a shape of a circle, a square, an oval that is similar to a circle, or a rectangle that is similar to a square. When the second opening 220 has a shape of a circle, the narrowest width W2 of the second opening 220 may be the diameter of the second opening 220. When the second opening 220 has a shape of a square, the narrowest width W2 of the second opening 220 may be a side of the second opening 220.

When a plurality of pads 112 are formed, a plurality of second openings 220 may be formed to correspond to the number of pads 112. As is described below, the second opening 220 may be electrically connected to a bump.

The photoresist pattern 120 may further include at least a dummy opening 250 separated and spaced apart from the first opening 210 and the second opening 220. The dummy opening 250 may have a cross-section substantially the same as or similar to that of the second opening 220. The narrowest width W3 of the dummy opening 250 may be equal to the narrowest width W2 of the second opening 220.

The number of dummy openings 250 formed is not limited to one, regardless of the number of pads 112 or second openings 220 formed. The dummy opening 250 may expose a portion of the seed layer 110 above the passivation film 104. The dummy opening 250 may be formed to expose only a portion of the seed layer 110 above the passivation film 104 and not to expose the seed layer 110 formed above the pad 112.

FIG. 7 is a cross-sectional view showing an operation of forming a filler layer 114, according to example embodiments of inventive concepts.

Referring to FIG. 7, the filler layer 114 may be formed on the semiconductor substrate 100 above which the photoresist pattern 120 is formed. The filler layer 114 may be formed in the opening pattern 200 of the photoresist pattern 120. The filler layer 114 may also be formed in the dummy opening 250 of the photoresist pattern 120. The filler layer 114 may be formed by electroplating. The electroplating for forming the filler layer 114 may be referred to as a first electroplating.

A portion of the filler layer 114 formed in the first opening 210 is referred to as a first filler layer 114a, a portion of the filler layer 114 formed in the second opening 220 is referred to as a second filler layer 114b, and a portion of the filler layer 114 formed in the dummy opening 250 is referred to as a dummy filler layer 114d.

A portion of the first filler layer 114a formed on the pad 112 may have a thickness equal to that of the first filler layer 114a formed on the passivation film 104 (t1a=t1b). Also, the first filler layer 114a, the second filler layer 114b, and the dummy filler layer 114d may be formed to have the same thickness.

The filler layer 114 may be formed by first placing the semiconductor substrate 100, on which the photoresist pattern 120 is formed, into a bath and then by performing the first electroplating operation. The filler layer 114 may be formed of a metal selected from the group consisting of Cu, Ni, Au, and an alloy of these metals or a multiple layer structure of metals selected from the group consisting of Cu, Ni, and Au.

The filler layer 114 may be formed to have a narrower width consistent with the photoresist pattern 120 formed by a photolithography process is used. For example, the first filler layer 114a may be formed to have a width narrower than that of the second filler layer 114b and/or the dummy filler layer 114d. The filler layer 114 may be formed to fill only portions of the opening pattern 200 and the dummy opening 250, instead of completely filling the opening pattern 200 and the dummy opening 250. That is, the filler layer 114 may be formed to have a thickness thinner than that of the photoresist pattern 120.

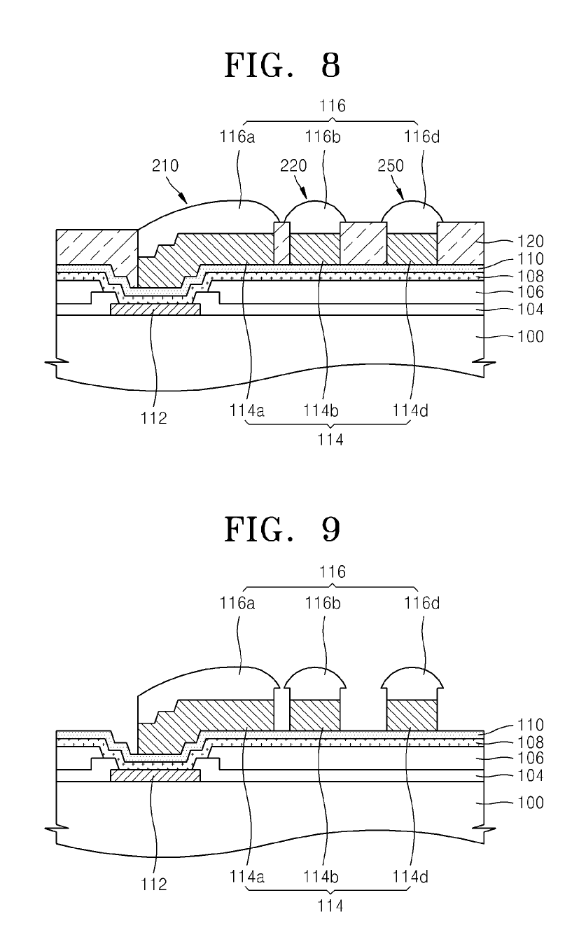

FIG. 8 is a cross-sectional view showing an operation of forming a solder layer 116 according to example embodiments of inventive concepts.

Referring to FIG. 8, the solder layer 116 may be formed on the filler layer 114. The solder layer 116 may be formed on the first filler layer 114a, the second filler layer 114b, and/or the dummy filler layer 114d of the filler layer 114. The solder layer 116 may be formed to protrude higher than the uppermost surface of the photoresist pattern 120. The solder layer 116 may be formed by a second electroplating operation. The electroplating for forming the solder layer 116 is referred to as a second electroplating while the first electroplating is used for forming the filler layer 114; these terms are used simply to distinguish the electroplating processes.

A portion of the solder layer 116 formed on the first opening 210 is referred to as a first solder layer 116a, a portion of the solder layer 116 formed on the second opening 220 is referred to as a second solder layer 116b, and a portion of the solder layer 116 formed on the dummy opening 250 is referred to as a dummy solder layer 116d.

In order form the solder layer 116, a second electroplating may be performed by placing the semiconductor substrate 100 on which the filler layer 114 is formed in a second bath. The second bath may be different from the first bath which was used to form the filler layer 114. The solder layer 116 may be an alloy of Sn and Ag, and if necessary, any of: Cu, Pd, Bi, or Sb may be added.

The solder layer 116 may be formed to partly extend beyond a side of the filler layer 114 on the photoresist pattern 120.

FIG. 9 is a cross-sectional view showing an operation of removing the photoresist pattern 120, according to example embodiments of inventive concepts.

Referring to FIG. 9, after forming the solder layer 116, the photoresist pattern 120 depicted in FIG. 8 is removed. In order to remove the photoresist pattern 120, a strip process or an ashing process may be performed.

The first filler layer 114a and the first solder layer 116a may be separate from and spaced apart from the second filler layer 114b and the second solder layer 116b, respectively. The dummy filler layer 114d and the dummy solder layer 116d may be separate from the first filler layer 114a and the first solder layer 116a. The dummy filler layer 114d may also be separate and spaced apart from the second filler layer 114b and the second solder layer 116b, respectively.

After removing the photoresist pattern 120, a process of removing a natural oxide film (not shown) formed on, for example, an upper surface of the semiconductor substrate 100, or on an upper surface of the seed layer 110 or on a surface of the filler layer 114, may be performed. In order to remove the natural oxide film, the natural oxide film may be heat treated using formic acid HCO₂H, a carboxylic acid, or another appropriate acid. After finely and uniformly distributing particles of formic acid which may be in an aerosol state, the natural oxide film may be removed by performing a heat treatment at a temperature in a range from about 200 C to about 250 C.

The heat treatment that uses formic acid may be performed instead of using flux for removing the natural oxide film. When a liquid flux is used for removing the natural oxide film, wettability of the filler layer 114 may be improved so that the solder layer 116 may easily melt and cover the surface of the filler layer 114, also the natural oxide film formed on the surface of the filler layer 114 is removed due to the use of liquid flux. However, when the flux is used, flux residue may remain on the seed layer 110. Therefore, when the seed layer 110 is removed through wet etching in a subsequent process, the seed layer 110 in the area where the flux residue remains may not be removed.

When a heat treatment process is used to remove a natural oxide film by using formic acid instead of using a flux process, an additional process for removing the flux is unnecessary when formic acid in an aerosol state is used instead of liquid flux.

In order to remove a natural oxide film through a flux process, a washing solution for flux removal may be used. However, the washing solution for flux removal is expensive and a large cost is required for managing and maintaining the washing solution for flux removal in a suitable state. However, when the natural oxide film is removed by the formic acid heat treatment, the above-described problems may be avoided.

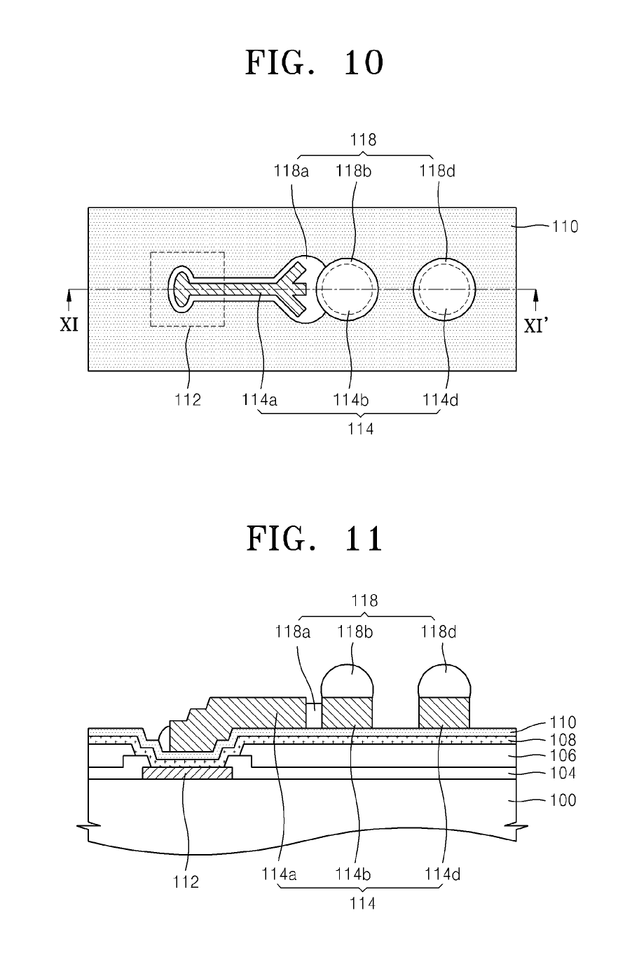

FIG. 10 is a plan view showing an operation of performing a reflow process, and FIG. 11 is a cross sectional view showing an operation of performing a reflow process according to example embodiments of inventive concepts. More specifically, FIG. 11 is a cross-sectional view taken along the line XI-XI′ of FIG. 10.

Referring to FIGS. 9 through 11, a reflow process is performed by heat treating the semiconductor substrate 100 from which the photoresist pattern 120 of FIG. 8 has been removed. The reflow process may be performed at a temperature in a range from about 220 C to about 260 C. The solder layer 116 of FIG. 9 is melted by the reflow process, and thus, a reflow solder 118 may be formed. The reflow solder 118 may include a collapsed solder layer 118a and a solder bump 118b.

The second solder layer 116b of FIG. 9 is not dissolved after melting and may form the solder bump 118b on the second filler layer 114b due to surface tension, and an inter-metal compound (IMC) (not shown) may be formed at an interface between the solder bump 118b and the second filler layer 114b.

The first solder layer 116a of FIG. 9 is dissolved after melting and may form the collapsed solder layer 118a on the first filler layer 114a. The collapsed solder layer 118a may surround the first filler layer 114a after the first solder layer 116a that is melted by the reflow process dissolves on the first filler layer 114a. It is depicted that the uppermost surface of the collapsed solder layer 118a is lower than that of the first filler layer 114a. However, the uppermost surface of the collapsed solder layer 118a may be higher than that of the first filler layer 114a or a portion of the collapsed solder layer 118a may be on the first filler layer 114a. When the first solder layer 116a of FIG. 9 dissolves on the first filler layer 114a, the collapsed solder layer 118a may be disposed between the first filler layer 114a and the second filler layer 114b close to the second filler layer 114b. Thus, the collapsed solder layer 118a may directly contact the first and second filler layers 114a and 114b.

When the first solder layer 116a dissolves, the first solder layer 116a may be thicker towards the second filler layer 114b according to the shape of the first opening 210 of the photoresist pattern 120 as shown in FIG. 5. Because the shapes of the first opening 210 and the second opening 220 are the same as those of the first filler layer 114a and the second filler layer 114b, respectively, the first filler layer 114a may have a width narrower than that of the second filler layer 114b. Accordingly, the first solder layer 116a that is melted by the reflow process may remain on the second filler layer 114b due to surface tension. However, the first solder layer 116a that is melted by the reflow process may not remain on the first filler layer 114a that has a narrow width and may dissolve. At this point, the first solder layer 116a may be collapsed in the direction toward the second filler layer 114b by appropriately forming the shape of the first filler layer 114a, that is, the shape of the first opening 210 illustrated in FIG. 5. That is, when the segment that constitutes the first filler layer 114a is formed mainly towards the second filler layer 114b, the dissolution of the first solder layer 116a may be collapsed toward the second filler layer 114b due to the surface tension. Accordingly, the collapsed solder layer 118a is formed on the side of the second filler layer 114b, and thus may directly connect the first filler layer 114a to the second filler layer 114b.

The collapsed solder layer 118a may cover a portion of the seed layer 110 around the first filler layer 114a and the collapsed solder layer 118a may electrically connect the first filler layer 114a and the second filler layer 114b. That is, the collapsed solder layer 118a may surround the periphery of the first filler layer 114a.

The reflow solder 118 may further include a dummy solder bump 118d. The dummy solder bump 118d may be formed on the dummy filler layer 114d due to surface tension of the dummy solder layer 116d on the dummy filler layer 114d after the dummy solder layer 116d is melted by a reflow process. An inter metallic compound (IMC) (not shown) may be formed at an interface between the dummy solder bump 118d and the dummy filler layer 114d. The dummy solder bump 118d may have a shape that is substantially the same as or nearly similar to that of the solder bump 118b.

Afterwards, optionally, particles of formic acid remaining on the semiconductor substrate 100 may be removed by performing a washing process using deionized (DI) water.

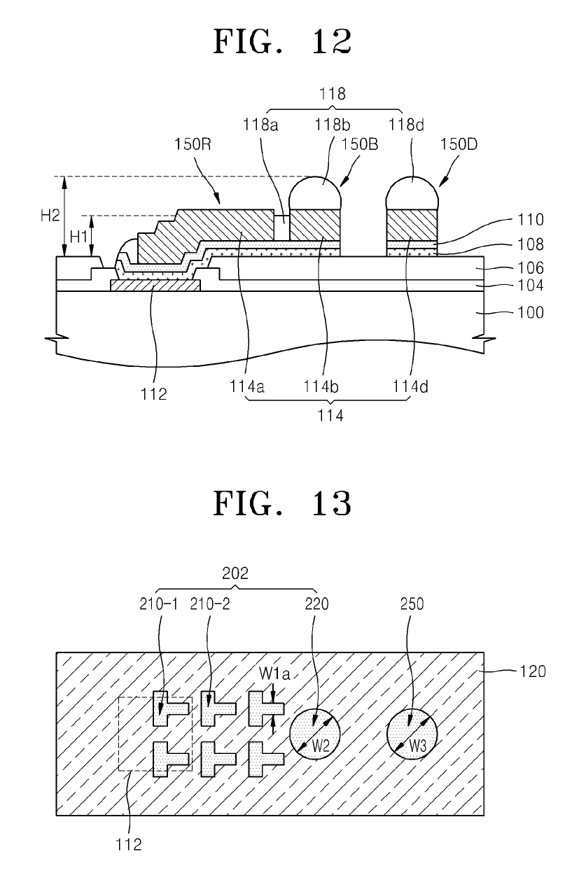

FIG. 12 is a cross-sectional view showing an operation of forming connection bumps, according to example embodiments of inventive concepts.

Referring to FIG. 12, portions of the seed layer 110 that are not covered by the filler layer 114 and the collapsed solder layer 118a to be exposed and the barrier wall layer 108 under the uncovered seed layer 110 are removed. In order to remove the portions of the seed layer 110 and the barrier wall layer 108, a wet etching may be performed by using an etchant, for example, hydrogen peroxide H₂O₂. During wet etching for removing the portions of the seed layer 110 and the barrier wall layer 108, a portion of sidewalls of the filler layer 114 may be removed, and thus, areas of the cross-section of the filler layer 114 may be partly reduced. However, since the reflow process was already performed, additional dissolution of the reflow solder 118 may not occur.

When the parts of the seed layer 110 that are not covered by the filler layer 114 and the collapsed solder layer 118a to be exposed and the barrier wall layer 108 under the uncovered seed layer 110 are removed, a connection bump 150B, a rewiring pattern 150R, and a dummy connection bump 150D may be formed. The connection bump 150B may include the second filler layer 114b and the solder bump 118b. The rewiring pattern 150R may include the first filler layer 114a and the collapsed solder layer 118a. The dummy connection bump 150D may include dummy filler layer 114d and the dummy solder bump 118d.

The connection bump 150B may be electrically connected to the pad 112 through the rewiring pattern 150R. The dummy connection bump 150D may be electrically insulated from the connection bump 150B. Also, the dummy connection bump 150D may be insulated from the rewiring pattern 150R, and accordingly, may be insulated from the pad 112. Accordingly, the first filler layer 114a, the second filler layer 114b, the collapsed solder layer 118a, and the solder bump 118b may be electrically insulated from the dummy connection bump 150D, which includes the dummy filler layer 114d and the dummy solder bump 118d.

The connection bump 150B may be formed to have the same shape as the dummy connection bump 150D. However, although the connection bump 150B is electrically connected to the pad 112 through the rewiring pattern 150R, the dummy connection bump 150D may be electrically floated. The connection bump 150B may be used for electrically connecting semiconductor devices included in the semiconductor substrate 100 to an external device, for example, a board such as a printed circuit board (PCB) or another semiconductor chip through the pad 112. However, the dummy connection bump 150D may function to maintain a distance between the semiconductor substrate 100 and an external device, for example, a board such as a printed circuit board (PCB) or another semiconductor chip, and may prevent bending of or damage to the semiconductor substrate 100 when a pressure is applied to the semiconductor substrate 100.

The uppermost surfaces of the connection bump 150B and the dummy connection bump 150D on the semiconductor substrate 100 may be at the same level with respect to the semiconductor substrate 100. That is, the uppermost surfaces of the solder bump 118b and the dummy solder bump 118d may be formed at the same level by performing a reflow process. Accordingly, the connection bump 150B and the dummy connection bump 150D may have an equal height on the passivation film 104 and the buffer insulating film 106.

However, the uppermost surface of the collapsed solder layer 118a may be formed at a lower level than the uppermost surfaces of both, the solder bump 118b and the dummy solder bump 118d, by performing a reflow process. FIG. 12 illustrates the uppermost surface of the collapsed solder layer 118a is lower than the uppermost surfaces of the second filler layer 114b and the dummy filler layer 114d. However, the uppermost surface of the collapsed solder layer 118a may be formed at a higher level than the uppermost surfaces of the second filler layer 114b and the dummy filler layer 114d and at a lower level than the uppermost surfaces of the solder bump 118b and the dummy solder bump 118d.

When a connection bump is formed on a pad without forming a rewiring pattern, the uppermost surfaces of the connection bump and the dummy connection bump may have a coplanarity problem, which may cause a failure in a semiconductor assembly process. However, since the uppermost surfaces of the connection bump 150B and the dummy connection bump 150D according to the current embodiment are at the same level, such a failure in a semiconductor assembly process may be avoided. Also, since the connection bump 150B is not located on the pad 112, stress may not be applied to the pad 112 in a semiconductor assembly process.

Also, since the rewiring pattern 150R may be formed by performing only a single photolithography process for forming the filler layer 114, an additional photolithography process for forming the rewiring pattern 150R that connects the connection bump 150B to the pad 112 is not performed, thereby reducing a process time and costs.

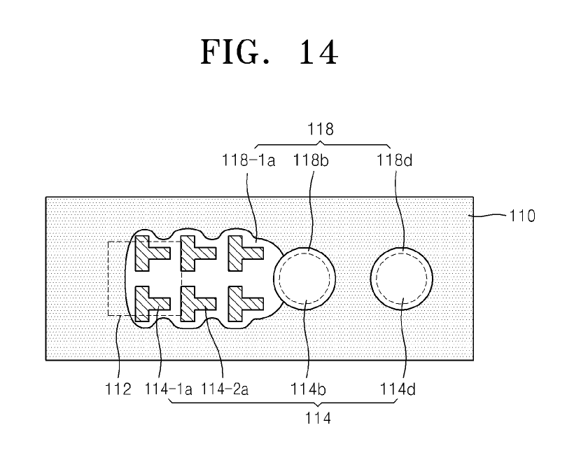

FIGS. 13 and 14 are plan views showing operations of forming a photoresist pattern 120 and a collapsed solder layer 118a, according to other example embodiments of inventive concepts. FIGS. 13 and 14 are plan views corresponding to the plan views of FIGS. 5 and 10, respectively. Like reference numerals refer to elements described with reference to FIGS. 1 through 12 and repeated descriptions thereof are omitted.

Referring to FIG. 13, the photoresist pattern 120 is formed on the seed layer 110. The photoresist pattern 120 may include an opening pattern 202 that exposes a portion of the seed layer 110. The opening pattern 202 may include a first opening 210-1 and a second opening 220. The opening pattern 202 may further include a middle opening 210-2. The first opening 210-1 may expose a portion of the seed layer 110 on the pad 112. The middle opening 210-2 may be between the first opening 210-1 and the second opening 220 and may be separated respectively from the first opening 210-1 and the second opening 220. The middle opening 210-2 may expose a portion of the seed layer 110 on the passivation film 104.

The number of first openings 210-1 and middle openings 210-2 formed, may be greater than one. Also, one or more middle openings 210-2 may be formed with respect to each single first opening 210-1.

Cross sections of the first opening 210-1 and the middle opening 210-2 may have the same shape. The first opening 210-1 and the middle opening 210-2 may be openings having the same shape and may be repeatedly formed towards the second opening 220 over the pad 112.

When the first opening 210-1 and the middle opening 210-2 have the same shape, the first opening 210 may be referred to as an opening formed to expose a portion of the seed layer 110 on the pad 112 and a portion of the seed layer 110 on the passivation film 104, and the middle opening 210-2 may be referred to as an opening formed to expose only a portion of the seed layer 110 on the passivation film 104 and not to expose the portion of the seed layer 110 formed on the pad 112.

The narrowest widths W1a of the first opening 210-1 and the middle opening 210-2 may be smaller than the narrowest width W2 of the second opening 220. All widths of the first opening 210-1 and the middle opening 210-2 may be formed smaller than the narrowest width W2 of the second opening 220. That is, the first opening 210-1 and the middle opening 210-2 may be formed as a linear opening or a combination of linear openings having a width smaller than the narrowest width W2 of the second opening 220.

Referring to FIGS. 13 and 14, after forming the filler layer 114 in the opening pattern 202 and forming a solder layer similar to the solder layer 116 shown in FIG. 9 on the filler layer 114, a collapsed solder layer 118-1a and the solder bump 118b may be formed by performing a reflow process.

By comparing the current embodiment shown in FIGS. 13 and 14 to the previous embodiment shown in FIGS. 1 through 12, in the current embodiment, in order to form the collapsed solder layer 118-1a that electrically connects the pad 112 to the solder bump 118b, the photoresist pattern 120 that includes the opening pattern 202 is formed to form a segment of a first filler layer 114-1a and a segment of a middle filler layer 114-2a, that is, a plurality of segments of the filler layer 114 that are separated from each other. When the segments of the filler layer 114 are used, the direction of dissolution may be finely controlled when the solder layer dissolves by performing a reflow process for forming the collapsed solder layer 118-1a.

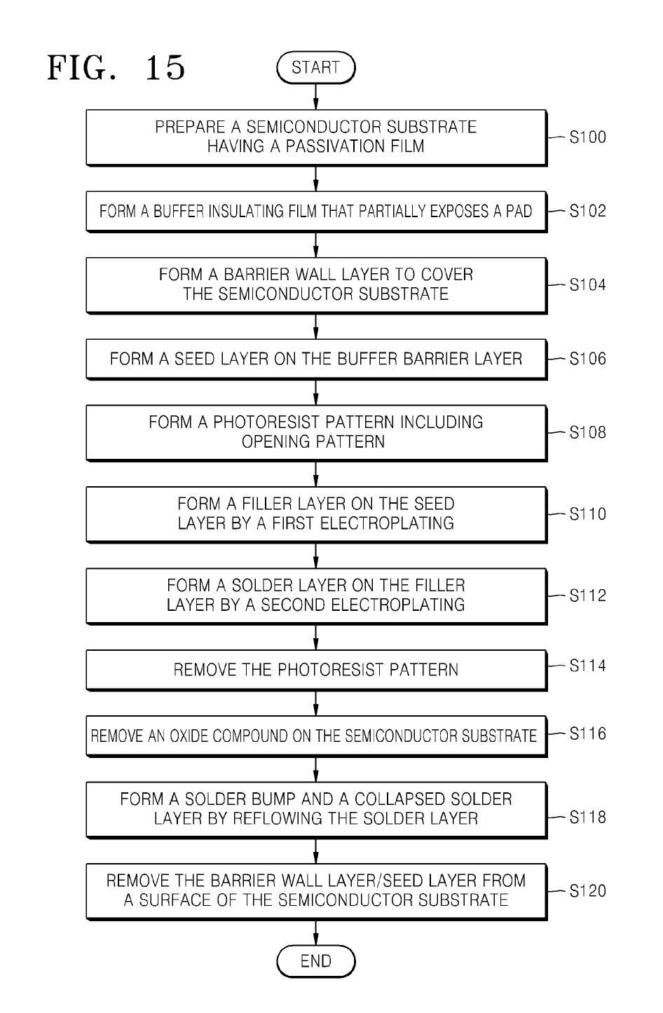

FIG. 15 is a flowchart illustrating a method of forming a bump, according to example embodiments of inventive concepts. For convenience of understanding, the method of forming a bump will be described with reference to FIGS. 1 through 14.

Referring to FIG. 15, the semiconductor substrate 100 on which the passivation film 104 which is the final protection film is formed is prepared (S100). Next, the buffer insulating film 106 that partially exposes the pad 112 on the semiconductor substrate 100 is formed (S102). Next, the barrier wall layer 108 that covers the entire semiconductor substrate 100 is formed (S104), and the seed layer 110 is formed on the barrier wall layer 108 (S106).

The photoresist pattern 120 that includes the opening pattern 202 that partially exposes the seed layer 110 is formed (S108), and a first electroplating process is performed to form the filler layer 114 on the seed layer 110 (S110). Next, a second electroplating process is performed to form the solder layer 116 on the filler layer 114 (S112), and the photoresist pattern 120 used as the electroplating shielding film is removed (S114).

Next, a natural oxide film on the semiconductor substrate 100 is removed by performing a heat treatment with formic acid and not a flux treatment (116). Next, the solder bump 118b and the collapsed solder layer 118a are formed by performing a reflow process (S118). Afterwards, the exposed seed layer 110 on a surface of the semiconductor substrate 100 and the barrier wall layer 108 under the seed layer 110 are removed through an etching process (S120).

While inventive concepts have been particularly shown and described with reference to example embodiments thereof, it will be understood that various changes in form and details may be made therein without departing from the spirit and scope of the following claims.

What is claimed is:

1. A method of forming a connection bump of a semiconductor device, the method comprising:
preparing a semiconductor substrate on which a pad is partially exposed through a passivation film;
forming a seed layer on the pad and the passivation film;
forming a photoresist pattern including an opening pattern, the opening pattern including;
a first opening that exposes a portion of the seed layer on the pad; and
a second opening that exposes a portion of the seed layer on the passivation film and is separated from the first opening;
performing a first electroplating to form filler layers in the opening patterns;
performing a second electroplating to form a solder layer on the filler layers;
removing the photoresist pattern; and
performing a reflow process to form a collapsed solder layer that electrically connects the filler layers to each other and to a solder bump on the filler layer formed in the second opening.

2. The method of claim 1, wherein the performing the reflow process includes forming the collapsed solder layer by dissolving a portion of the solder layer that is formed on the filler layer formed in the first opening.

3. The method of claim 1, further comprising removing a portion of the seed layer exposed by the filler layers and the collapsed solder layer after performing the reflow process.

4. The method of claim 1, wherein a narrowest width of the first opening is smaller than the narrowest width of the second opening so that the collapsed solder layer is formed by dissolving a portion of the solder layer that is formed on the filler layer formed in the first opening and the solder bump is formed by the solder layer that is formed on the filler layer formed in the second opening.

5. The method of claim 1, wherein the opening patterns further comprise at least one middle opening that is between the first opening and the second opening and wherein the at least one middle opening is separated from the first opening and the second opening.

6. The method of claim 5, wherein the cross sections of the first opening and the at least one middle opening have the same shape, and wherein the first opening and the at least one middle opening are repeatedly disposed in a direction towards the second opening.

7. The method of claim 4, wherein the performing the reflow process includes forming the collapsed solder layer by dissolving a portion of the solder layer formed on the filler layer that is formed in the first opening and in the middle opening.

8. The method of claim 7, wherein the performing the reflow process includes forming the collapsed solder layer by dissolving a portion of the solder layer that is formed on the filler layer formed in the first opening and the middle opening so that the collapsed solder layer contacts the filler layer formed in the second opening.

9. The method of claim 1, wherein the forming the photoresist pattern further includes forming the photoresist pattern that corresponds to a dummy opening that is separated from the opening pattern and exposes a portion of the seed layer on the passivation film,
the performing the first electroplating includes forming a dummy filler layer in the dummy opening, and
the forming the second electroplating includes forming the dummy solder layer on the dummy filler layer.

10. The method of claim 9, wherein the performing the reflow process includes forming the dummy solder bump on the dummy filler layer.

11. The method of claim 10, wherein the performing the reflow process includes forming the uppermost surfaces of the solder bump and the dummy solder bump on the semiconductor substrate at the same level.

12. The method of claim 10, wherein the performing the reflow process includes forming the uppermost surface of the collapsed solder layer at a lower level than the uppermost surface of the solder bump on the semiconductor substrate.

13. The method of claim 10, further comprising;
removing the portions of the seed layer exposed by the filler layers and the collapsed solder layer so that the filler layer, the solder bump, and the collapsed solder layer respectively are electrically insulated from the dummy filler layer and the dummy solder bump after performing the reflow process.

14. A method of forming a connection bump of a semiconductor device, the method comprising:
preparing a semiconductor substrate on which a pad is partially exposed through a passivation film;
forming filler layers separated from each other, each of the filler layers including,
a bump filler pattern on the passivation film,
a connection filler pattern on the pad to partly overlap with the pad, and
at least one middle filler pattern between the bump filler pattern and the connection filler pattern;
forming a solder layer on the filler layers; and
forming a collapsed solder layer that electrically connects the pad to the bump filler pattern by dissolving the solder layer formed on the connection filler pattern and the middle filler pattern.

15. The method of claim 14, wherein the filler pattern further includes an auxiliary filler pattern that is on the passivation film and is separated from the bump filler pattern, the connection filler pattern, and the middle filler pattern,
the forming the collapsed solder layer includes electrically insulating the pad from the auxiliary filler pattern.

16. A method of forming a connection bump of a semiconductor device, the semiconductor device including a first filler layer with a solder layer on the first filler layer, a second filler layer with a solder bump on the second filler layer and a pad, the pad being partly covered by the first filler layer, layer, the method comprising:
forming a collapsed solder layer on the semiconductor device, and
electrically connecting the first filler layer, the second filler layer, the pad and the solder bump.

17. The method of claim 16 further comprising;
forming the first filler layer to have a width smaller than a width of the second filler layer.

18. The method of claim 16 further comprising;
finely controlling a direction of collapsing the solder layer.

19. The method of claim 18 further comprising;
forming a dummy filler layer on the semiconductor device, and
forming a dummy solder bump on the dummy filler layer.

20. The method of claim 19 wherein the forming the dummy filler layer and the forming the dummy solder bump are performed such that the dummy filler layer and the dummy solder bump are electrically insulated from the pad.
